(19) United States
(12) Patent Application Publication
(10) Pub. No.: US 2004/0181939 A1
(43) Pub. Date: Sep. 23, 2004

(54) Method of producing optical fiber

(75) Inventors: Tatsuhiko Saitoh, Kanagawa (JP); Shinji Ishikawa, Kanagawa (JP)

Correspondence Address: McDERMOTT, WILL & EMERY, 600 13th Street, N.W., Washington, DC, 20005-3096, US

(73) Assignee: SUMITOMO ELECTRIC INDUSTRIES, LTD.

(21) Appl. No.: 10/764,454

(22) Filed: Jan. 27, 2004

(30) Foreign Application Priority Data
Feb. 12, 2003 (JP) 2003-034252

(51) Int. Cl. G02B 6/04

(52) U.S. Cl. 29/868; 29/850; 385/120

(57) ABSTRACT

The present invention provides a method of producing an optical fiber having a decreased transmission loss and air holes extending in the axial direction of the fiber. The method of the present invention includes a first step of preparing an optical fiber preform having through holes for forming the air holes, a second step of drawing the optical fiber preform in a drawing furnace to form an optical fiber having the air holes, and a third step of heating the optical fiber at a temperature in the range of 900° C. to 1300° C. in an additional heating furnace provided downstream of the drawing furnace.

### BACKGROUND OF THE INVENTION

1. Field of the Invention

The present invention relates to a method of producing an optical fiber having air holes extending in the axial direction of the fiber.

2. Description of the Related Art

Examples of an optical fiber having air holes extending in the axial direction (longitudinal direction) of the fiber are so-called holey fibers and photonic crystal fibers. In the microstructured optical fiber, characteristics superior to those of an optical fiber having no air hole can be obtained since a difference between the mean refractive index of a core region and that of a cladding region can be controlled by controlling the size and arrangement of the air holes in a cross-section perpendicular to the fiber axis. Thus, it is expected that the microstructured optical fiber is applied to a nonlinear fiber and dispersion compensation fiber, for example, because higher nonlinearity and wavelength dispersion of a larger absolute value can be achieved in the microstructured optical fiber, as compared with an optical fiber having no air hole.

The transmission loss of a microstructured optical fiber is greater than that of an optical fiber having no air hole. Therefore, studies have been made for decreasing the transmission loss. It is known that the microstructured optical fiber has a relatively small transmission loss when the ratio of energy of light present in the air holes relative to the whole energy of light traveling through the microstructured optical fiber is low. As an example of such a microstructured optical fiber having a small transmission loss, Japanese Unexamined Patent Application Publication No. 2002-31737 discloses an optical fiber comprising a core region, a three-layer cladding region surrounding the core region, and air holes provided in the outermost layer of the cladding region. Since the optical fiber has the two layers between the core region and the layer having the air holes, the ratio of the energy of light present in the air holes is decreased.

Although it is known that the transmission loss of the microstructured optical fiber is increased due to the air holes, no research has been made for determining what factor of the air holes causes the transmission loss. Therefore, in order to decrease the transmission loss, it has been inevitable that the air holes be disposed apart from the core region. Since the characteristics of the microstructured optical fiber depend upon the arrangement of the air holes, a limitation in the way of air hole arrangement possibly results in a failure in sufficiently achieving properties, such as a wavelength dispersion, to be realized by the microstructured optical fiber.

### SUMMARY OF THE INVENTION

It is an object of the present invention to provide a method of producing a microstructured optical fiber in which a transmission loss is decreased without a limitation in terms of refractive index profiles in a core region and a cladding region, or without a limitation with respect to the arrangement of air holes in a section perpendicular to the fiber axis.

In order to achieve the object, a method of producing an optical fiber of the present invention comprises a first step of preparing an optical fiber preform having through holes which are to be formed into air holes, a second step of drawing, in a drawing furnace, the optical fiber preform into an optical fiber having the air holes, and a third step of heating the optical fiber to a temperature in the range of 900° C. to 1300° C. in an additional heating furnace provided downstream of the drawing furnace.

Advantages of the present invention will become readily apparent from the following detailed description, which illustrates the best mode contemplated for carrying out the invention. The invention is capable of other and different embodiments, the details of which are capable of modifications in various obvious respects, all without departing from the invention. Accordingly, the drawing and description are illustrative in nature, not restrictive.

### BRIEF DESCRIPTION OF THE DRAWINGS

The present invention is illustrated by way of example, and not by way of limitation, in the figures of the accompanying drawing in which like reference numerals refer to similar elements and in which:

FIG. 1 is a perspective view showing an example of a microstructured optical fiber;

FIG. 2 is a sectional view, which is taken along a plane perpendicular to the fiber axis, of an optical fiber preform for producing the microstructured optical fiber shown in FIG. 1;

FIG. 3 is a schematic view showing a drawing tower for drawing the optical fiber preform shown in FIG. 2;

FIG. 4 is a graph showing the transmission loss of each of microstructured optical fibers of Examples 1 to 4 and Comparative Example;

FIG. 5 is a graph showing the transmission loss of a microstructured optical fiber at a wavelength of 1550 nm; and

FIG. 6 is a graph showing the dispersion value of a microstructured optical fiber at a wavelength of 1550 nm.

### DESCRIPTION OF THE PREFERRED EMBODIMENTS

The inventors conducted intensive studies on a decrease in transmission loss of an optical fiber having air holes extending in the axial direction of the fiber, i.e., a so-called microstructured optical fiber. It is known that the transmission loss is small when the ratio of the energy of light present in the air holes is low relative to the whole energy of light traveling in a microstructured optical fiber. However, the air hole (the inside of the air hole) itself, which is air, cannot be the cause of a transmission loss. The inventors have studied Rayleigh scattering at the interfaces of the air holes as a possible cause of the transmission loss. As a result of studying the transmission loss in terms of its dependency on wavelength, it was confirmed that the transmission loss is due to Rayleigh scattering at the interfaces of the air holes. As a result of further studies on Rayleigh scattering at the interfaces of the air holes, the inventors found the following.

The microstructured optical fiber is produced by drawing an optical fiber preform having through holes which are thereby formed into air holes. The optical fiber preform is usually made of silica glass as its main component, which is composed of Si and O arranged in a network structure. When such an optical fiber preform is heated and melted in a drawing furnace, SiO gas is produced in the through holes.

When the microstructured optical fiber is removed from the drawing furnace and cooled, the produced SiO gas adheres to the interfaces of the air holes. SiO is frozen before coming into a stably bonded state because the cooling rate of the optical fiber removed from the drawing furnace is 5000° C./second or higher. Namely, SiO unstably adheres to the interfaces of the air holes of the microstructured optical fiber. In a portion where SiO unstably adheres, i.e., a portion where the atomic arrangement at the interface of each air hole is disordered, fluctuation of dielectric constant is increased, whereby Rayleigh scattering is increased. Therefore, the transmission loss of the microstructured optical fiber is increased.

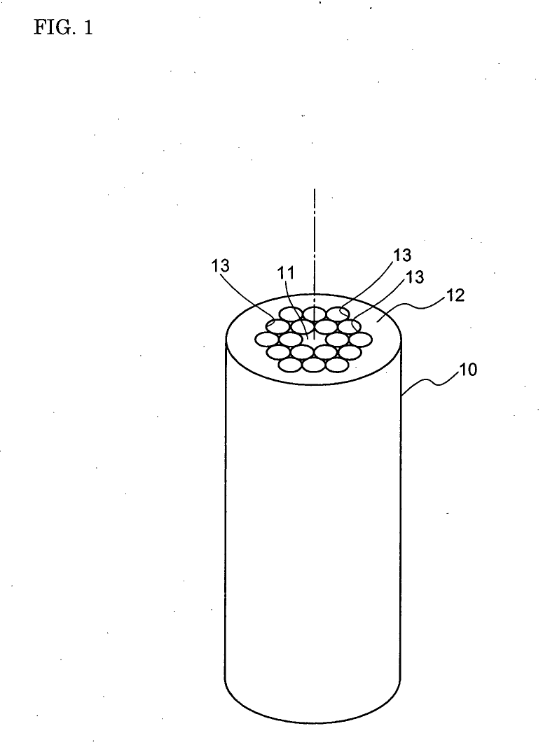

FIG. 1 is a perspective view showing an example of a microstructured optical fiber. The microstructure optical fiber 10 shown in FIG. 1 comprises a core region 11 extending along the fiber axis, and a cladding region 12 surrounding the periphery of the core region 11. The cladding region 12 has a plurality of air holes 13 formed around the core region 11 and extending along the fiber axis. In a section perpendicular to the fiber axis of the microstructured optical fiber 10, the air holes 13 are arranged in a hexagonal lattice around the core region 11.

Since the microstructured optical fiber 10 has the air holes 13 formed in the cladding region 12, the mean refractive index of the cladding region 12 is smaller than that of an optical fiber having no air hole 13. Thus, a difference between the refractive indexes of the core region 11 and the cladding region 12 is greater than that of an optical fiber in which the air holes are not formed in the cladding region 12.

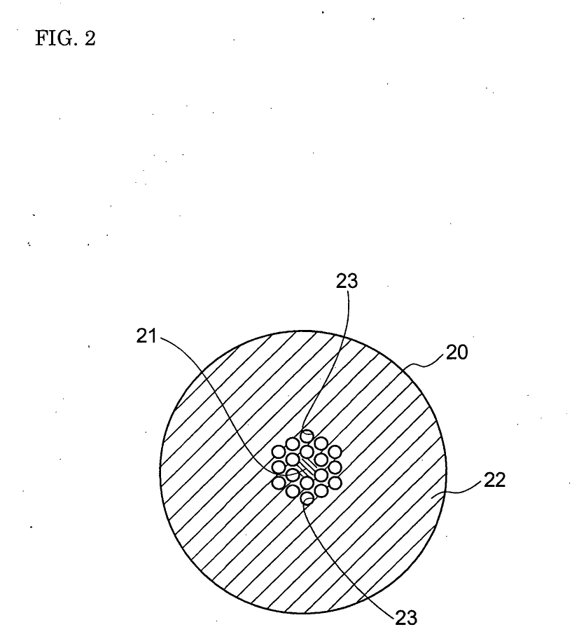

A method of producing the microstructured optical fiber 10 according to an embodiment of the present invention will be described below. First, an optical fiber preform 20 is prepared (first step). FIG. 2 is a sectional view of the optical fiber preform 20, taken along a plane perpendicular to the fiber axis. The optical fiber preform 20 comprises a first region 21, which becomes the core region 11, and a second region 22, which becomes the cladding region 12. The first region 21 and the second region 22 may have the same composition. The second region 22 has through holes 23 which are to be transformed into the air holes 13. In a cross-section, the through holes 23 are arranged in a hexagonal lattice around the first region 21. The optical fiber preform 20 is formed in a manner in which the first region 21 and the second region 22 are first formed by vapor phase axial deposition (VAD), modified chemical vapor deposition (MCVD) or outside vapor deposition (OVD), and then the through holes 23 are formed in the second region 22. The through holes 23 may be formed by, for example, a boring instrument.

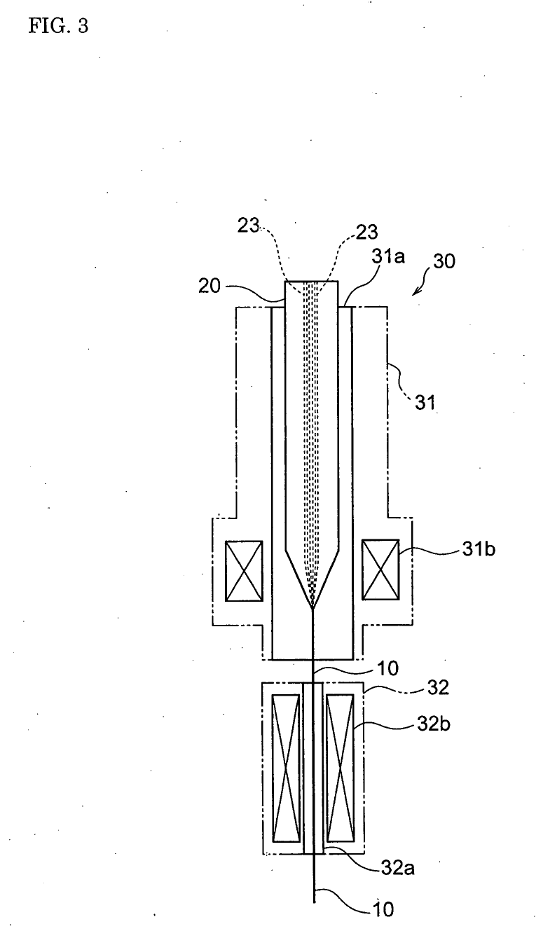

Next, the optical fiber preform 20 is drawn into a fiber (second step). FIG. 3 is a schematic diagram showing a drawing tower 30 for drawing the optical fiber preform 20. The drawing tower 30 comprises a drawing furnace 31 and an additional heating furnace 32.

The drawing furnace 31 includes a cylindrical furnace muffle 31a and a heater 31b. Also, a preform feeding device, which is not shown in the figure, is provided above the drawing furnace 31. Thus, the optical fiber preform 20 can be maintained in the furnace muffle 31a. The heater 31b is disposed at the lower side of the drawing furnace 31 so as to surround the periphery of the furnace muffle 31a.

The additional heating furnace 32 is disposed at a position which is distanced from the drawing furnace 31 in the drawing direction of the optical fiber 10. The additional heating furnace 32 comprises a cylindrical furnace muffle 32a and a heater 32b. The heater 32b is disposed outside the furnace muffle 32a so as to surround the periphery of the furnace muffle 32a.

The optical fiber preform 20 is set in the preform feeding device so as to be held in the furnace muffle 31a of the drawing furnace 31. Then, the heater 31b is operated for heating the furnace muffle 31a. As a result of heating the furnace muffle 31a, an end of the optical fiber preform 20 is heated and melt-drawn so as to produce the microstructured optical fiber 10.

The temperature of the heater 31b is sufficient if it is not less than a temperature capable of melting the optical fiber preform 20; preferably the optical fiber preform 20 is drawn at a temperature of 1950° C. or less. This is because if the temperature of the optical fiber preform 20 is about 1950° C. or less, the generation of SiO gas can be suppressed, although the Si—O bond of silica glass which constitutes the optical fiber preform 20 is broken to generate SiO gas in the through holes 23 when the optical fiber preform 20 is heated and melted. In this case, the ratio of SiO adhering to the interfaces of the air holes in the optical fiber formed by drawing the optical fiber preform can be decreased.

In drawing, an inert gas with high thermal conductivity is supplied as an atmospheric gas into the furnace muffle 31a. Particularly, the atmospheric gas preferably contains helium gas. The helium gas is an inert gas causing no chemical reaction with optical fibers. Also, the helium gas has high thermal conductivity and can effectively cool the microstructured optical fiber 10 discharged from the heater 31b. The inert gas may be supplied from an inert 15′ gas supply source connected to the furnace muffle 31a.

Furthermore, oxygen gas is preferably present in the through holes 23 of the optical fiber preform 20. During drawing, SiO gas is generated in the through holes 23, as described above. However, the generation of the SiO gas can be suppressed because the equilibrium of Eq. 1 below is shifted to the right side as a result of the presence of the oxygen gas.

SiO+½O₂→SiO₂ (1)

Next, the microstructured optical fiber 10 drawn in the drawing furnace 31 is pulled out downward from the bottom of the furnace muffle 31a of the drawing furnace 31, and air-cooled between the drawing furnace 31 and the additional heating furnace 32. Subsequently, the microstructured optical fiber 10 proceeds to the additional heating furnace 32. Then, the heater 32b is operated to heat the furnace muffle 32a, for heating the microstructured optical fiber 10 (third step). The heating temperature of the microstructured optical fiber 10 may be set to a temperature suitable for stabilizing the bond of SiO that has adhered to the interfaces of the air holes 13 by air-cooling. However, the heating temperature of the microstructured optical fiber 10 is preferably in the range of 900° C. to 1300° C. and higher than the temperature after air-cooling.

Air-cooling the optical fiber between the drawing furnace and the additional heating furnace, which is disposed apart from the drawing furnace, is preferable because the ratio of SiO which adheres to the interfaces of the air holes is increased by such air-cooling before the passage through the additional heating furnace. This is because at the time of the passage through the additional heating furnace, the stabilization of Si—O bond according to the present invention is afforded to the SiO that has adhered to the interfaces of the air holes, while such stabilization is not afforded to the SiO gas remaining in the spaces of the air holes. The SiO gas remaining in the spaces of the air holes during the passage through the additional heating furnace adheres to the inner surfaces of the air holes in an unstable state of bond after the passage through the additional heating furnace, and such unstable SiO increases Rayleigh scattering.

When the optical fiber at a high temperature is put into the additional heating furnace, the number of molecules in the state of SiO gas is large, which results in a small effect in terms of the stabilization of Si—O bond. On the other hand, when the temperature of the optical fiber is decreased before putting the optical fiber into the additional heating furnace, the ratio of the SiO gas becomes low, which results in a large effect of stabilization. The microstructured optical fiber 10 is preferably cooled to a temperature in the range of 900° C. to 1300° C. or a lower temperature before being inserted into the additional heating furnace 32.

In the third step, the microstructured optical fiber 10 is preferably heated at a temperature in the range of 900° C. to 1300° C. for 0.1 second or more in the additional heating furnace 32. With a heating time of less than 0.1 second, unstable Si—O bond is not completely converted to stable bond. With a heating time of 0.1 second or more, the SiO adhering to the interfaces of the air holes of the optical fiber can be securely brought into a stably bonded state.

During heating of the microstructured optical fiber 10 in the additional heating furnace 32, an inert gas having low thermal conductivity is supplied as an atmospheric gas into the furnace muffle 32a of the additional heating furnace 32. Particularly, the atmospheric gas preferably contains a nitrogen gas. The nitrogen gas is an inert gas causing no chemical reaction with optical fibers. Since the microstructured optical fiber 10 is not rapidly cooled because of the low thermal conductivity of the nitrogen gas, the microstructured optical fiber 10 is maintained at a high temperature for an elongated time after the passage through the additional heating furnace, and consequently Si and O can be brought into a more stably bonded state.

The operation and advantage of the method of producing the microstructured optical fiber 10 of the above-described embodiment will be described below. A conventional microstructured optical fiber is produced only by drawing an optical fiber preform. Therefore, SiO unstably adheres to the interfaces of the air holes 13. In such a microstructured optical fiber, the atomic arrangement at the interface of each air hole is disordered in a portion where SiO adheres. In the portion where the atomic arrangement is disordered, Rayleigh scattering of guided light is increased, whereby the transmission loss in the microstructured optical fiber is increased.

On the other hand, in this embodiment, as described above, the microstructured optical fiber 10 is re-heated in the additional heating furnace 32 provided downstream of the drawing furnace 31, and thus stable Si—O bond of SiO adhering to the interfaces of the air holes 13 can be realized. Thus, Rayleigh scattering of guided light at the interfaces of the air holes 13 can be suppressed in the microstructured optical fiber 10 that has passed through the additional heating furnace 32. Therefore, the transmission loss of guided light in the microstructured optical fiber 10 can be decreased.

In the third step, it is important to heat the microstructured optical fiber 10 in the temperature range of 900° C. to 1300° C. When the optical fiber is heated at a temperature higher than 1300° C., the air holes 13 are possibly collapsed or deformed. Each of the air holes 13 usually has a diameter of as small as several μm or less, and the geometrical shape of the air holes 13 is easily deformed by heating. The excellent properties of the microstructured optical fiber 10, such as high nonlinearity and wavelength dispersion with a high absolute value, are realized by controlling the size and arrangement of the air holes 13. It is thus important to attain the size and arrangement of the air holes precisely according to the design values.

On the other hand, in order that SiO adhering to the interfaces of the air holes 13 is brought into a stable Si—O bond state, heating must be performed at a temperature higher than the temperature at which SiO₂ softens, i.e., the softening temperature (about 900° C.). Viewed in the atomic level, softening of glass is a phenomenon in which the state of Si—O bond can be changing. The unstable Si—O bond is converted to stable bond which has lower energy when the SiO having unstable Si—O bond at the interfaces of the air holes is maintained at a higher temperature than the softening point. As a result, the disorder in the atomic arrangement at the interfaces of the air holes is reduced, and the fluctuation of dielectric constant is decreased, which results in the decrease of Rayleigh scattering.

As described above, when the microstructured optical fiber 10 is heated at a temperature in the range of 900° C. to 1300° C., SiO unstably adhering to the interfaces of the air holes 13 can be put into a stable Si—O bond state while collapsing or deformation of the air holes 13 is suppressed. Therefore, an optical fiber in which Rayleigh scattering is reduced can be produced without deforming the geometrical shape of air holes in a section perpendicular to the fiber axis. From the viewpoint of the suppression of collapsing or deformation of the air holes, the optical fiber is preferably heated at a temperature in the range of 900° C. to 1100° C. in the additional heating furnace.

As described above, in the microstructured optical fiber of this embodiment, Rayleigh scattering at the interfaces of the air holes 13, which possibly causes a transmission loss, is suppressed to decrease the transmission loss. Thus, unlike the conventional technique, in the microstructured optical fiber 10, which is not limited in terms of structure for decreasing the transmission loss, it is possible to realize desired properties such as wavelength dispersion with a high absolute value, while the transmission loss is decreased.

Examples of the microstructured optical fiber 10 produced by the method of the present invention and a comparative example are described below. The microstructured optical fibers of Examples 1 to 4 were produced by using the drawing tower shown in FIG. 3 as follows.

First, the optical fiber preform 20 shown in FIG. 2 was set in a preform feeding device, and maintained in the drawing furnace 31. The optical fiber preform 20 had the first region 21 and the second region 22 each composed of pure silica glass.

Then, the optical fiber preform 20 was heated and met-drawn at a temperature of 1940° C. by the drawing furnace 31 to obtain the microstructured optical fiber 10. Then, the microstructured optical fiber 10 was air-cooled between the drawing furnace 31 and the additional heating furnace 32, and then sent to the additional heating furnace 32 for re-heating the microstructured optical fiber 10. In this step, helium gas was supplied to the drawing furnace 31, and nitrogen gas was supplied to the additional heating furnace 32. Furthermore, oxygen gas was present in the through holes 23.

In producing the microstructured optical fibers of Examples 1 to 4, each of the microstructured optical fibers was heated in the additional heating furnace 32 as follows. In Example 1, the optical fiber was heated at 1000° C. for 1 second; in Example 2, the optical fiber was heated at 1100° C. for 0.5 second; in Example 3, the optical fiber was heated at 1200° C. for 0.5 second; and in Example 4, the optical fiber was heated at 1300° C. for 0.3 second.

As described above, the microstructured optical fibers of Examples 1 to 4 were produced under the same production conditions except that the heating conditions in the additional heating furnace 32 were different. A microstructured optical fiber of the comparative example was produced by drawing the optical fiber preform 20 in the drawing furnace 31 under the same production conditions as those for producing the microstructured optical fiber of Example 1 except that heating in the additional heating furnace 32 was not carried out.

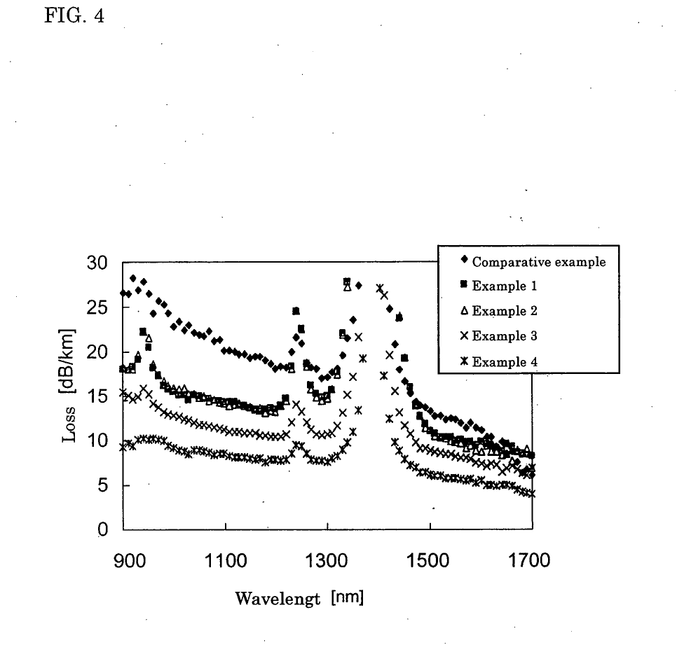

Then, the transmission loss of each of the microstructured optical fibers of Examples 1 to 4 and the comparative example was examined. In FIG. 4, the abscissa shows the wavelength of guided light, and the ordinate shows the transmission loss. It is known from FIG. 4 that the microstructured optical fibers of Examples 1 to 4 produce smaller transmission losses than that of the microstructured optical fiber of the comparative example. In FIG. 4, the transmission loss is increased at about 1240 nm and 1380 nm due to the absorption by H₂ and OH groups, respectively.

The method of producing the microstructured optical fibers of Examples 1 to 4 is the same as that for producing the microstructured optical fiber of the comparative example except that in the case of Examples 1 to 4 the microstructure optical fiber 10 discharged from the drawing furnace 31 is re-heated in the additional heating furnace 32. It is thus found that the decrease in the transmission loss shown in FIG. 4 is due to heating in the additional heating furnace 32 for converting the atomic arrangements at the interfaces of the air holes 13 to a stable state, as described above.

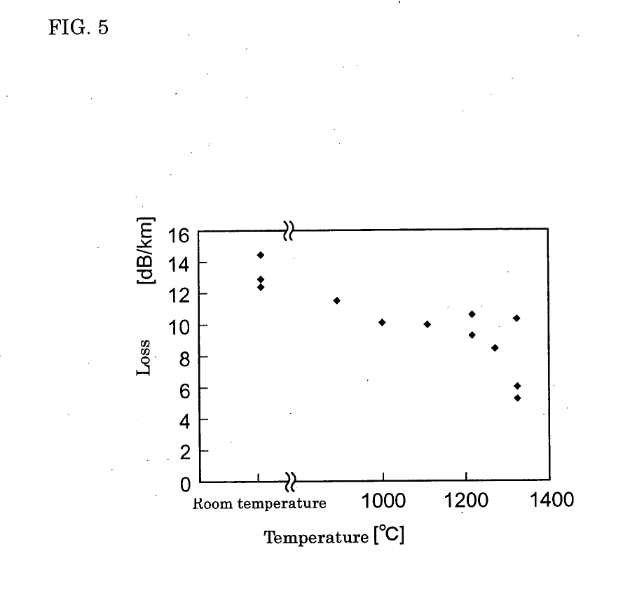

FIG. 5 shows the transmission loss of guided light at a wavelength of 1550 nm in the microstructured optical fiber 10. In FIG. 5, the abscissa shows the heating temperature of the microstructure optical fiber 10 in the additional heating furnace 32, and the ordinate shows the transmission loss of guided light at a wavelength of 1550 nm. The measurement results of the microstructured optical fiber produced without heating in the additional heating furnace 32 are plotted as measurement results at room temperature. The measurement results at room temperature are plotted for the sake of convenience of comparison with the measurement results of the microstructured optical fiber 10 produced by heating in the additional heating furnace 32. FIG. 5 indicates that the transmission loss of the guided light in the microstructured optical fiber 10 produced by heating to a temperature in the range of 900° C. to 1300° C. is decreased at a wavelength of 1550 nm, in which the minimum transmission loss is realized in an optical fiber composed of silica glass as a main component.

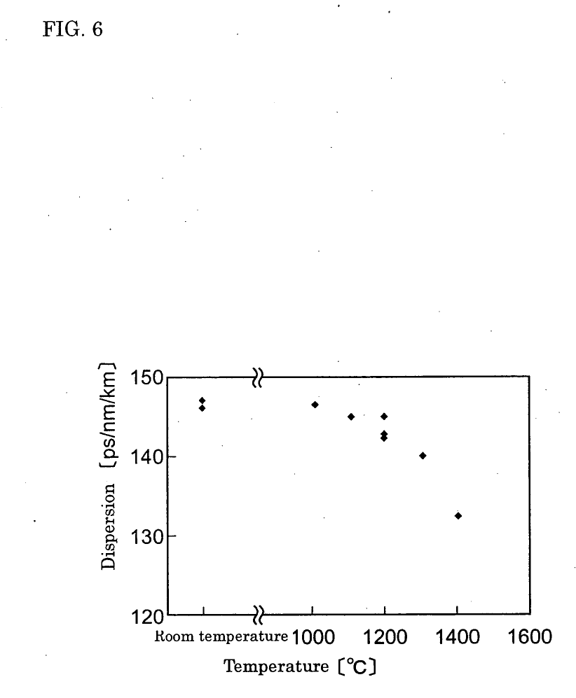

FIG. 6 shows the dispersion value of guided light at a wavelength of 1550 nm in the microstructured optical fiber 10. In FIG. 6, the heating temperature of the microstructured optical fiber 10 in the additional heating furnace 32 is shown as the abscissa, and the dispersion value of guided light at a wavelength of 1550 nm is shown as the ordinate. In FIG. 6, the measurement results of a microstructured optical fiber produced without heating in the additional heating furnace 32 are plotted, as in FIG. 5, as measurement results at room temperature.

FIG. 6 indicates that the dispersion value decreases as the heating temperature in the additional heating furnace 32 increases. The decrease in the dispersion value is considered to be due to heating in the additional heating furnace 32, which has caused the deformation of the air holes of the microstructured optical fiber 10. It can also be recognized from FIG. 6 that in order to prevent the dispersion value of the microstructured optical fiber 10 from being diverted from the dispersion value of the microstructured optical fiber produced without heating in the additional heating furnace 32, the heating temperature in the additional heating furnace must be appropriately set. Also, since the dispersion value of the microstructured optical fiber produced by heating at 1400° C. in the additional heating furnace 32 is abruptly decreased, the microstructured optical fiber 10 is preferably heated at a temperature in the range of 900° C. to 1300° C., and more preferably in the range of 900° C. to 1100° C., in the additional heating furnace 32.

While this invention has been described in connection with what is presently considered to be the most practical and preferred embodiments, the invention is not limited to the disclosed embodiments, but on the contrary, is intended to cover various modifications and equivalent arrangements included within the spirit and scope of the appended claims.

For example, the air holes may be arranged in a manner other than a hexagonal lattice. The air holes may be arranged in an any manner suitable for realizing desired properties of a microstructured optical fiber, such as wavelength dispersion with a high absolute value, and an effective core sectional area larger or smaller than that of an optical fiber having no air hole. Also, an additive (for example, germanium oxide) for increasing a refractive index may be added to the core region 11, or an additive for decreasing a refractive index may be added. Furthermore, no additive may be added. The core region 11 may be hollow. Although, in a preferred embodiment of the present invention, a microstructured optical fiber is air-cooled and then re-heated in an additional heating furnace, the microstructured optical fiber 10 may be sent to the additional heating furnace 32 immediately after drawing, and then air-cooled. In this case, the heating temperature may be controlled so that SiO stably adheres to the interfaces of the air holes 13.

The entire disclosure of Japanese Patent Application No. 2003-034252 filed on Feb. 12, 2003 including specification, claims, drawings and summary are incorporated herein by reference in its entirety.

What is claimed is:

1. A method of producing an optical fiber having air holes extending in the axial direction of the fiber, the method comprising:
a first step of preparing an optical fiber preform having through holes to be formed into the air holes;
a second step of drawing the optical fiber preform in a drawing furnace to form an optical fiber having the air holes; and
a third step of heating the optical fiber to a temperature in the range of 900° C. to 1300° C. in an additional heating furnace provided downstream of the drawing furnace.

2. A method of producing an optical fiber according to claim 1, wherein in the third step, the optical fiber is heated to a temperature in the range of 900° C. to 1300° C. for 0.1 second or more.

3. A method of producing an optical fiber according to claim 1, wherein in the third step, the optical fiber is heated to a temperature in the range of 900° C. to 1300° C., the temperature being higher than the minimum temperature of the optical fiber located between the drawing furnace and the additional heating furnace.

4. The method of producing an optical fiber according to claim 3, wherein the additional heating furnace is disposed apart from the drawing furnace so as to air-cool the optical fiber between the additional heating furnace and the drawing furnace.

5. The method of producing an optical fiber according to claim 1, wherein the atmospheric gas in the drawing furnace contains a helium gas.

6. The method of producing an optical fiber according to claim 1, wherein the atmospheric gas in the additional heating furnace contains a nitrogen gas.

7. The method of producing an optical fiber according to claim 1, wherein an oxygen gas is present in the through holes.

8. The method of producing an optical fiber according to claim 1, wherein in the second step, the optical fiber preform is drawn by heating at a temperature of 1950° C. or less in the drawing furnace.
